(19) United States
(12) Patent Application Publication
(10) Pub. No.: US 2021/0178627 A1
(43) Pub. Date: Jun. 17, 2021

(54) POWER TOOL GUIDE WITH POSITIVE ALIGNMENT

(71) Applicant: Affinity Tool Works, LLC, Troy, MI (US)

(72) Inventors: Mike Ursell, Bloomfield Hills, MI (US); Connor Ursell, Bloomfield Hills, MI (US); Ken Neilson, Rochester Hills, MI (US); Garry Favel, Kadarim (IL); Tsvi Hershkovitz, Karmiel (IL)

(21) Appl. No.: 17/121,962

(22) Filed: Dec. 15, 2020

Related U.S. Application Data
(60) Provisional application No. 62/948,767, filed on Dec. 16, 2019.

(51) Int. Cl. B27B 9/04

(52) U.S. Cl. CPC B27B 9/04

(57) ABSTRACT

A cutting tool guide having a base plate with a top face and bottom face. A first alignment member and a second alignment member are mounted to the top face. The first and second alignment members are positioned at a right angle to each other. At least one connector mounted to said first alignment member. A power tool with a shoe can be positioned upon the base plate top face with the shoe of the power tool engaging the first and second alignment members to accurately, quickly and positively align the power tool on the baseplate.

### CROSS-REFERENCE TO RELATED APPLICATIONS

This claims the benefit of U.S. Provisional Patent Application Ser. No. 62/948,767, filed Dec. 16, 2019, the entire disclosure of which is hereby incorporated by reference.

### TECHNICAL FIELD

This invention relates generally to power tool guides and more particularly to a versatile multifunctional power tool guide with positive alignment upon which a power tool can be mounted quickly with positive alignment and then used to guide the power tool to cut material along a straight edge and to rip material.

### BACKGROUND OF THE INVENTION

Power tool guides are well known in the wood working industry. Companies, such as, for example, Festool, Kreg, True Trac, and Urekazone sell power tool guides. The main problem with each of these tool guides is that they are dedicated to a specific straight edge and cannot be used on other types of straight edges. If a user doesn't have the straight edge required by the specific guide, the user cannot use the guide. This obviously results in the user being limited to a particular guide and a particular edge. Also, some of these guides are for a single purpose.

Other problems with known systems are more specific to each system. The Festool guide system requires a specific track as discussed above, in addition, the Festool system also requires a dedicated circular saw. Only the Festool saw can be used on the system. The Festool system is also very expensive when compared to other guide systems.

The Kreg system requires a specific track and is limited to a ripping function only. It doesn't have the ability to use the track as a guide for making guided cuts without the use of the edge of the material to act as a guide for the guide track.

The True Trac system is limited to a specific track and has the disadvantage of not being capable of doing rip cuts. Additionally, the True Trac requires a special mount that is difficult to mount to the saw. The mount is also intended to be permanently mounted to the saw. The True Trac will not allow other tools to be used on the track without attaching a separate mount to the tool.

The Eureka Zone system requires a specific track and is not adapted to be used to cut as a straight edge without the use of the material edge as a guide. It is also large and bulky and not easy to set up.

Another disadvantage with each of the above is the difficulty in mounting the cutting tool to the guide. None of them provide a quick easy way to positively align the tool on the guide.

### SUMMARY OF THE INVENTION

In general terms, the present invention provides an innovative versatile multi-function saw attachment guide, rail guide and rip attachment. The present invention solves the problems of known power tool guides and provides a compact, inexpensive, easy to assemble and easy to use solution to guided and rip cutting operations. The present guide also provides a positive alignment system that is quick, easy, and ensures the tool is properly mounted.

The multifunction cutting tool guide of the present invention includes a base plate having a top face and a bottom face. The base plate top face includes connection points for connecting a power tool to the base plate top face. The bottom face has guides to allow the saw plate to be guided on a straight edge to make a straight cut or connected to an attachment for making rip cuts and can be used by left or right-handed users.

A power tool can be attached to the base plate and the base plate can be positioned over a straight edge with the straight edge being received within one of the guides.

The plate of the present invention also allows the power tool to be more easily, accurately and positively attached to the plate due to the unique design. The present power tool guide provides a pair of straight alignment members at right angles to one another. The longitudinal edge of, for example, a saw shoe abuts the longitudinal alignment member and the lateral edge abuts the lateral member to ensure proper alignment of the saw. In the disclosed embodiment, locks are moveable along the longitudinal alignment member to secure the saw to the guide. A further lock can be provided to engage and secure the lateral edge of the shoe.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the multifunction cutting tool guide with positive alignment of the present invention.

FIG. 2 is a top view of the multifunction cutting tool guide with positive alignment of the present invention.

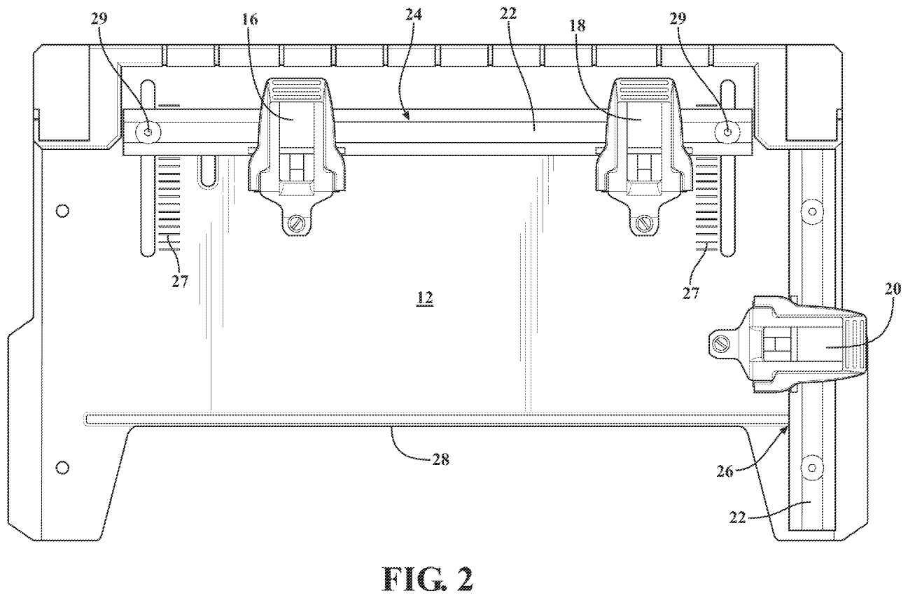

FIG. 3 is a rear perspective view of the multifunction cutting tool guide with positive alignment of the present invention.

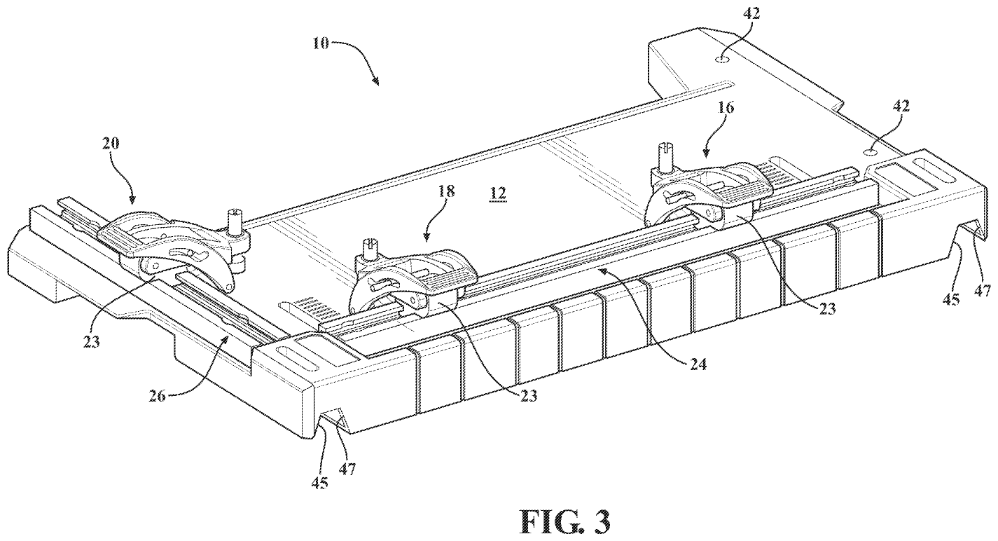

FIG. 4 is a rear perspective view of the multifunction cutting tool guide with positive alignment of the present invention with a circular saw shown in phantom.

FIG. 5 is a perspective view of the multifunction cutting tool guide with positive alignment of the present invention mounted upon a straight edge

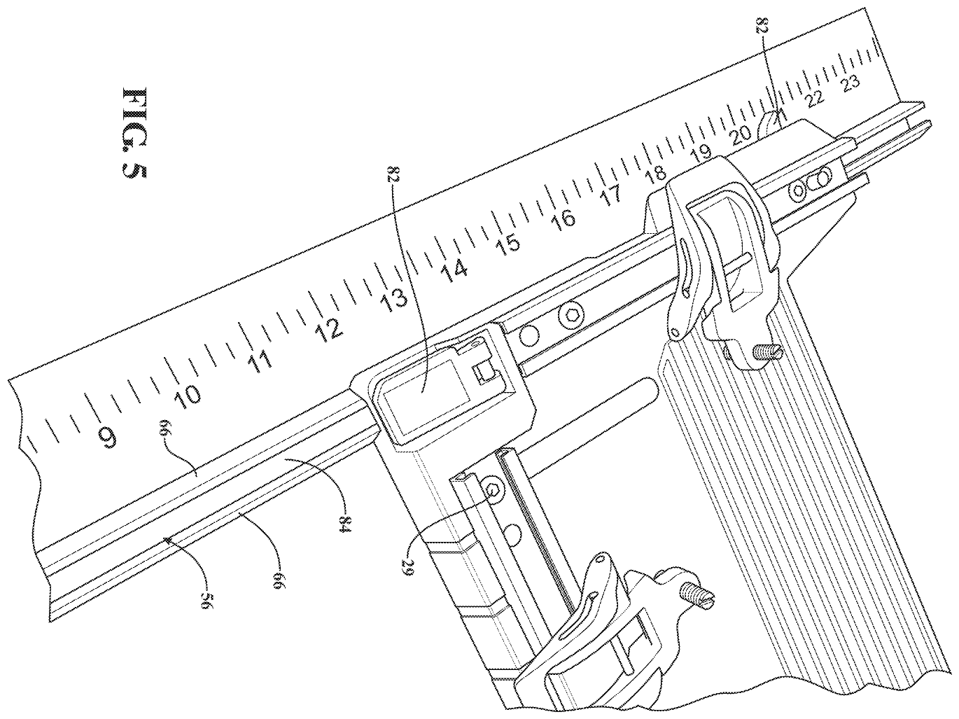

FIG. 6 is a perspective view of the multifunction cutting tool guide with positive alignment of the present invention mounted upon a rip cutting attachment.

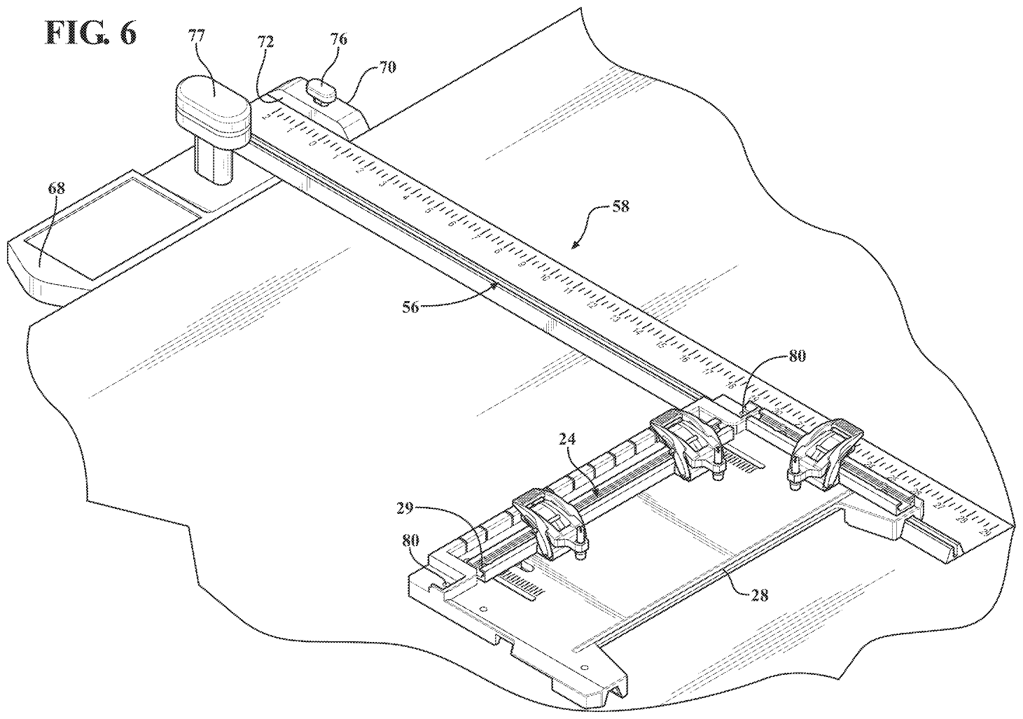

FIG. 7 is a perspective view of the multifunction cutting tool guide with positive alignment of the present invention illustrating the locking wedge.

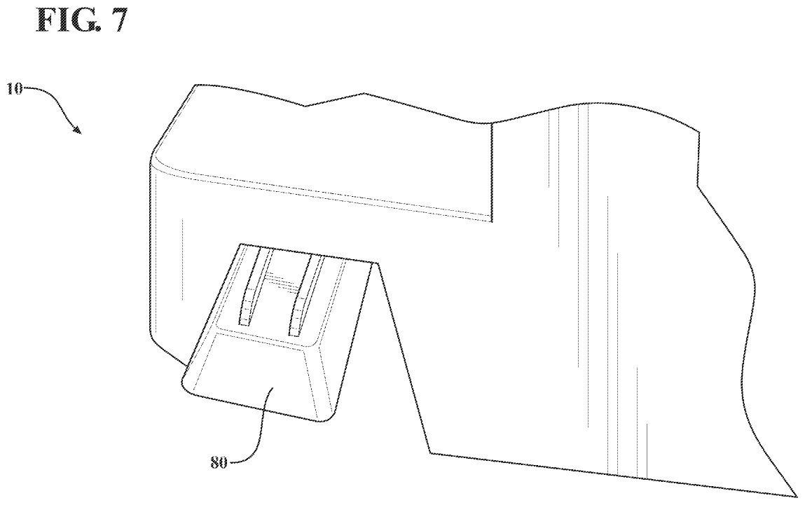

FIG. 8 is a perspective view of the bottom of the multifunction cutting tool guide with positive alignment of the present invention.

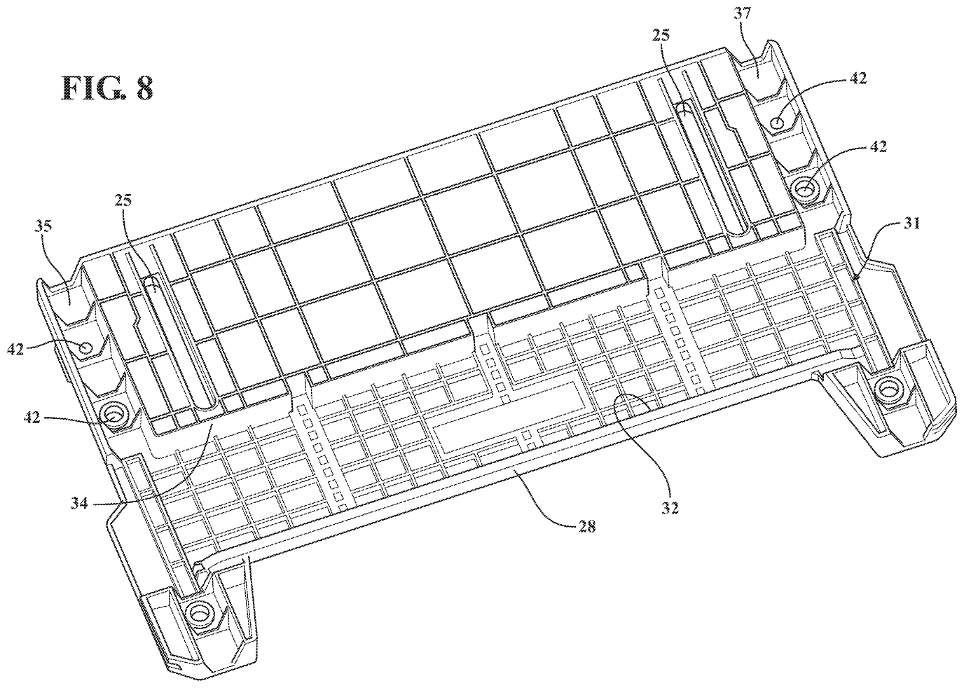

FIG. 9 is a perspective view of the multifunction cutting tool guide with positive alignment of the present invention mounted upon a straight edge.

### DETAILED DESCRIPTION OF A PREFERRED EMBODIMENT

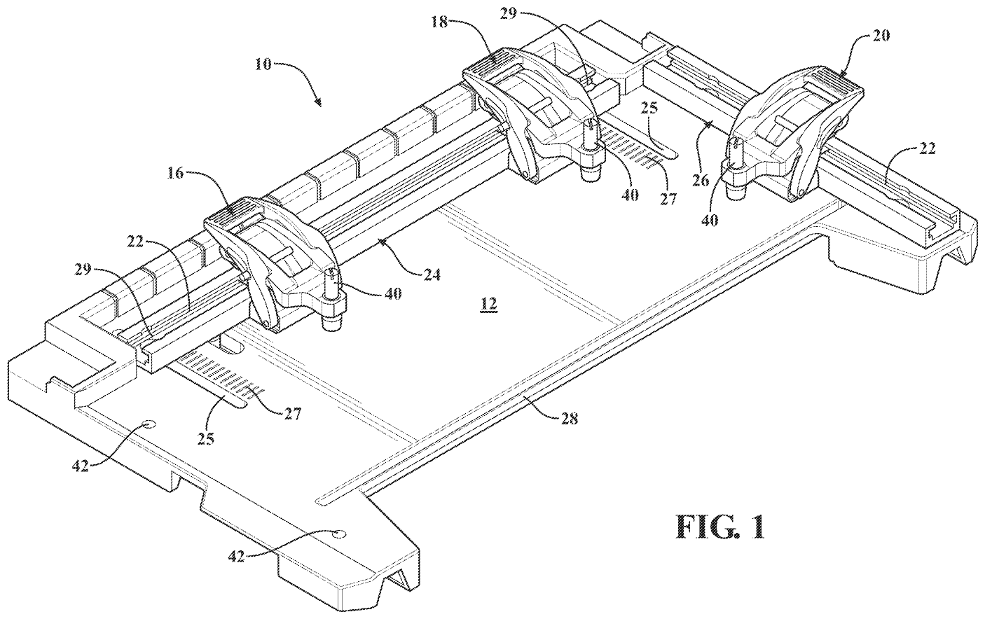

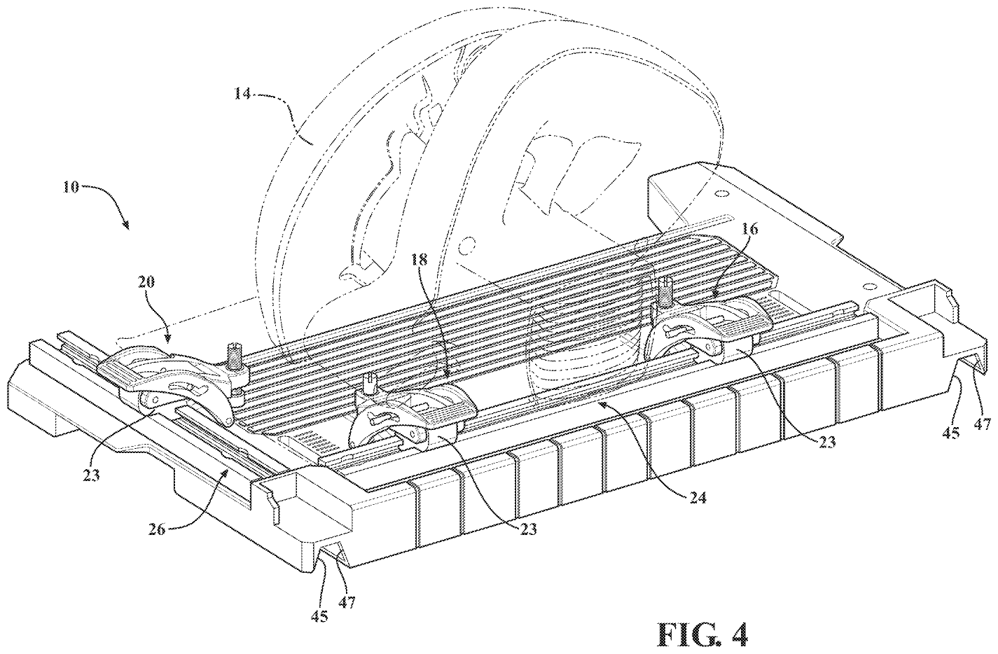

The cutting tool guide of the present invention is shown generally at 10 in FIG. 1. Guide 10 includes a base plate 12. In the disclosed embodiment, the plate 12 is made of molded plastic, however as is well known to those of ordinary skill in this art, other materials such as for example aluminum or a combination of aluminum and plastic, etc., could be used. Base plate 12 is generally flat and adapted to receive for example a power or cutting tool 14, such as for example a circular saw, jig saw, reciprocating saw, router, etc. See FIG. 4 for an example of a circular saw mounted to the base 12. In the disclosed embodiment, the base plate 12 includes three connectors 16, 18 and 20. The connectors 16, 18, and 20 are mounted within slots 22 in straight alignment members 24 and 26. Alignment members 24 and 26 are mounted at a right angle to one another. This allows the power tool 14 to be accurately, quickly and positively mounted to the base plate 12. The shoe of the power tool 14 is positioned on the plate 12 and pushed against the alignment members 24 and 26. When the shoe engages both alignment members 24 and 26, it is accurately mounted.

The connectors 16, 18 and 20 have lower portions 25 that extend into the slots 22 which allow the connectors 16 and 18 to be mounted to the base 12 and to slide along the alignment members 24 and 26. The connectors 16, 18 and 20 of the disclosed embodiment have threaded pins 40. The pins 40 thread against the shoe of a power or cutting tool 14, such as for example a circular saw, as illustrated in the figures. The connector 20 is mounted to slide along the alignment member 26 for engaging the lateral edge of the shoe. The connectors 16 and 18 are mounted to slide along the alignment member 24 for engaging the longitudinal edge of the shoe. This allows the guide 10 to be used on various power tools.

The guide 10 can also be used by a left-handed person or a right-handed person. The alignment member 26 can be removed and re-mounted to the opposite side of the base plate 12. In the disclosed embodiment, the alignment member 26 is mounted to mounting holes 42 on the opposite sides of the base plate 12. Depending upon whether left or right-handed use is desired, the alignment member is mounted to the appropriate side of the cutting tool guide 10.

The bottom of the base plate 12 has a straight edge cutting guide 31 that is defined by surfaces 32 and 34. The surfaces 32 and 34 allow the guide 10 to be used on standard straight edges, such as for example a three (3) inch straight edge 59.

Second and third rip guides 35 and 37 are positioned on the opposed sides 44 and 46 of plate 12. The rip guides 35 and 37 allow a rip guide to be attached to either side of the guide 10. The rip guide 58 illustrated includes the raised rail 56.

In use, a power tool 14, such as a circular saw 14, is attached to the base 12. The power tool 14 is positioned on the base 12 and the shoe of the power tool 14 engages both the alignment members 24 and 26. This accurately, correctly and positively aligns the power tool 14 on the guide 10. The connectors 16, 18 and 20 are slid over the shoe of the cutting tool 14 and are tightened against the shoe.

The blade of the tool 14 can be located with respect to the base plate cutting edge 28 by adjusting the straight edge alignment member 24. The alignment member 24 is mounted upon a track that allows movement upon the face 12 while maintaining the right angle between alignment members 24 and 26. The alignment member 24 is parallel to the base plate cutting edge 28. Notches 27 are provided to assist in keeping the alignment member 24 parallel as it is moved to position the saw blade adjacent edge 28. Once positioned, the member 24 can be locked down by fasteners 29. The fasteners are received in elongated openings 25 in the guide 10.

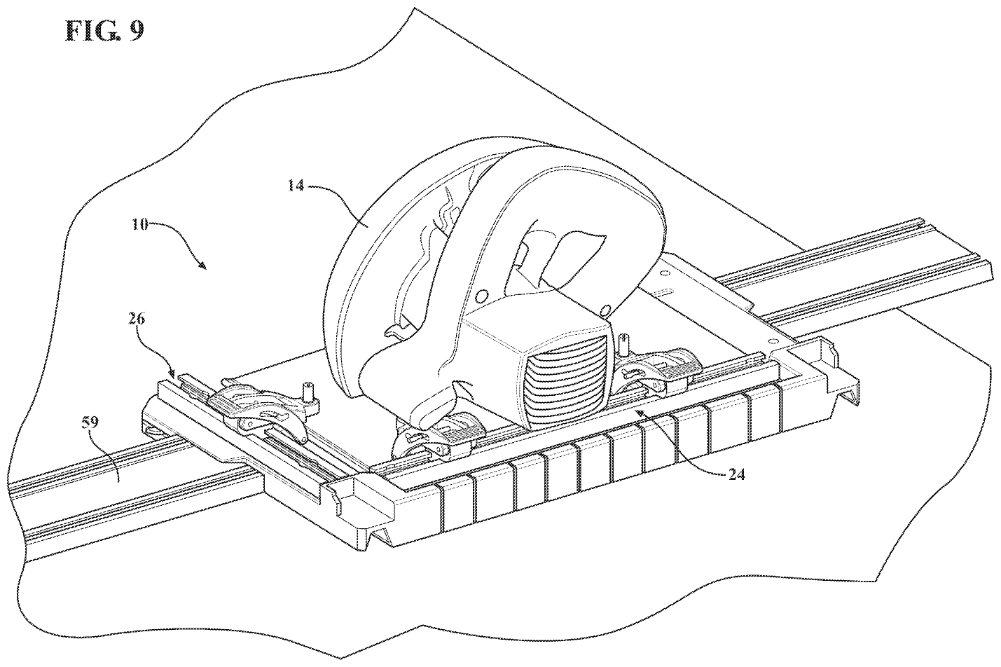

To make a straight cut, the straight edge 59 is fixed to the work piece, see FIG. 9. The straight edge 59 for example, could be a piece of wood, a metal ruler, or a commercial straight edge, such as those supplied by applicant under the trademark BORA®. The base 12 is positioned over the straight edge 59 with the straight edge 59 positioned between surfaces 32 and 34, which are spaced apart about 3 inches to engage the sides of the straight edge 59 and act as a guide. The base 12 can be moved along the straight edge 59 to cut the work piece in a straight guided line.

The base 12 can also be used as a ripping saw with a rip straight edge 58. The disclosed base plate 12 has a lateral channel 40 or 42 that slides over the raised rail 56 of the rip straight edge 58. In the disclosed embodiment, the lateral channel 40 or 42 and raised rail 56 have generally mating angled sidewalls 45 and 47 and 66. The angled sidewalls 45 and 47 mate with the sidewalls 66 to provide a more precise secure connection and provide a more tight connection when the base plate 12 is connected to the raised rail 56. This ensures that the base plate 12 doesn't move with respect to the rip straight edge 44. The raised rail 56 has a groove 84 that is adapted to receive a locking wedge 80 that includes a locking member 82.

The straight edge 58 also has a rip straight edge guide 68. The rip guide 68 includes a guide way 72 in mount 70. A locking member 76 is used to lock the rip guide 68 to the straight edge 58. In the disclosed embodiment, the locking member 76 is a threaded screw with a knob to facilitate the threading of the locking member against the straight edge 58. A handle 77 is provided on the rip guide 68 to facilitate movement of the saw 14 along the material to be ripped.

In use, the base plate 12 is positioned over the channel 66 with the wedge 80 inserted into the channel 66. Once positioned, the base 12 can be locked onto the straight edge 44 by engaging the locking member 80. The handle 68 can then be grasped and the saw moved along the work piece to rip a section from the material.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A cutting tool guide comprising:
a base plate having a top face and bottom face;
a first alignment member;
a second alignment member;
said first and second alignment members being connected to said top face with said first alignment member positioned at a right angle to said second alignment member;
at least one connector mounted to said first alignment member;
whereby a power tool with a shoe can be positioned upon said base plate top face with the shoe of the power tool engaging said first and second alignment members to accurately, quickly and positively align the power tool on said baseplate; said at least one connector being adapted to fix the power tool to said base plate.

2. The cutting tool guide of claim 1, wherein said first alignment member has a first slot which extends longitudinally along said first alignment member;
said at least one connector having a protrusion which mates with said first slot, said connector being movable within said first slot.

3. The cutting tool guide of claim 1, further including a second slot that extends longitudinally along said second alignment member; and
first, second, and third connectors, said first and second connectors mounted in said first slot in said first alignment member; and said third connector being mounted in said second slot;
each of said first, second and third connectors are adapted to engage the shoe of the power tool.

4. The cutting tool guide of claim 3, wherein said connectors have threaded ends that thread into a locked position.

5. The cutting tool guide of claim 1, wherein said base plate has opposed edges, said second alignment member being selectively mounted to either of said opposed ends for left-handed or right-handed operation of said base plate.

6. The cutting tool of claim 1, wherein said first alignment member is mounted upon a track to allow movement of said first alignment member upon said top face perpendicular to said second alignment member.

7. The cutting tool of claim 1, wherein said base plate includes a cutting edge, said first alignment member is mounted to said top face for movement with respect to said cutting edge.

8. The cutting tool of claim 7, further including a track;
said first alignment member is mounted on said track for parallel movement with respect to said cutting edge.

9. The cutting tool of claim 7, wherein said first alignment member includes first and second spaced projections;
said first and second spaced projections engaging said track.

10. The cutting tool of claim 9, wherein said spaced projections are threaded fasteners to fasten said first alignment member with respect to said base plate.

11. The cutting tool of claim 9, wherein said track is defined by first and second spaced elongated openings, said first spaced projection being received by said first spaced elongated opening and said second spaced projection being received by said second spaced elongated opening.

12. The cutting tool of claim 11, wherein said elongated openings are perpendicular to said first alignment member.

13. The cutting tool guide of claim 1, further including first and second guide channels located on said base plate member.

14. The cutting tool guide of claim 13, wherein said first guide is a straight edge cut guide and said second guide is a rip cut guide.

15. A cutting tool guide comprising:
a base plate having a top face, bottom face, and opposed edges;
a first alignment member;
a second alignment member;
said first and second alignment members being connected to said top face with said first alignment member positioned at a right angle to said second alignment member;
at least one connector mounted to said first alignment member;
said second alignment member being selectively mounted to either of said opposed ends for left-handed or right-handed operation of said base plate;
whereby a power tool with a shoe can be positioned upon said base plate top face with the shoe of the power tool engaging said first and second alignment members to accurately, quickly and positively align the power tool on said baseplate; said at least one connector being adapted to fix the power tool to said base plate.

16. The cutting tool of claim 15, wherein said first alignment member is mounted upon a track to allow movement of said first alignment member upon said top face perpendicular to said second alignment member.

17. The cutting tool of claim 15, wherein said base plate includes a cutting edge, said first alignment member is mounted to said top face for movement with respect to said cutting edge.

18. The cutting tool of claim 17, further including a track;
said first alignment member is mounted on said track for parallel movement with respect to said cutting edge.

19. The cutting tool guide of claim 15, further including first and second guide channels located on said base plate member.

20. The cutting tool guide of claim 19, wherein said first guide is a straight edge cut guide and said second guide is a rip cut guide.
